(19) United States
(12) Patent Application Publication
(10) Pub. No.: US 2025/0209795 A1
(43) Pub. Date: Jun. 26, 2025

(54) LIGHT DETECTION AND CLASSIFICATION FOR AN AUTONOMOUS DRIVING SYSTEM

(71) Applicant: Apollo Autonomous Driving USA LLC, Sunnyvale, CA (US)

(72) Inventor: Jeong Ho LYU, Sunnyvale, CA (US)

(73) Assignee: Apollo Autonomous Driving USA LLC, Sunnyvale, CA (US)

(21) Appl. No.: 18/391,354

(22) Filed: Dec. 20, 2023

(51) Int. Cl. G06V 10/771; G06V 10/60; G06V 10/764; G06V 20/56

(52) U.S. Cl. CPC G06V 10/771; G06V 10/60; G06V 10/764; G06V 20/56

(57) ABSTRACT

Embodiments presented herein include systems, methods, and non-transitory computer-readable medium or media for improved image processing, particularly when dealing with bright objects. Image sensor provides a wide range of data bit depth (e.g., 24 bits per channel). After receiving the image sensor data, there are several steps of signal processing to generate a better image quality, and the data bit depth is typically reduced (e.g., 8 bits per channel) in a process called tone mapping. However, tone mapping can generate artifacts such as color artifacts and gradient brightness of the light source, which can be problematic for applications like autonomous driving. Accordingly, embodiments herein provide ways for using a subset of high bit depth image data to skip the tone-mapping process. Embodiments may be used for improved detection and recognition/classification-especially of bright objects like traffic lights or any light source.

### TECHNICAL FIELD

Embodiments of the present disclosure relate generally to image processing. More particularly, embodiments of the disclosure relate to light detection, which may be used for autonomous driving systems as well as for other applications.

It shall be noted that the subject matter discussed in the background section should not be assumed to be prior art merely because of it being mentioned in this background section. Similarly, a problem mentioned in the background section or associated with the subject matter of the background section should not be assumed to have been previously recognized in the prior art. The subject matter in the background section merely represents different approaches, which in and of themselves may also be inventions.

### BACKGROUND

Currently, some vehicles are equipped with the ability to operate in an autonomous mode (or nearly autonomous mode). Vehicles operating in an autonomous mode can relieve the driver from at least some driving-related responsibilities. When operating in an autonomous mode, the vehicle can navigate to various locations using onboard sensors, allowing the vehicle to travel with minimal human interaction or in some cases without any passengers.

Among the most important system or systems for an autonomous driving vehicle are the onboard computers/processors/information handling systems, which are responsible for analyzing sensor data, making decisions, and controlling the vehicle. These computing systems, particularly those designed for autonomous driving (AD), comprise powerful processors (central processing units (CPUs), graphic processing units (GPUs), tensor processing units (TPUs), etc.).

For an AD computing system to function properly, it also requires support from a number of auxiliary systems. For example, autonomous vehicles rely heavily on imaging sensors that perceive the surrounding environment. Two image processing methods-image detection and image classification-enable AD systems to perceive and interpret their surroundings. These processes are essential for making real-time decisions to ensure safe and efficient navigation.

Image detection, which may also be referred to as object detection, is a computer vision task that involves identifying and locating objects or entities within a digital image. The goal of object detection is to determine the presence and spatial location of objects in an image. Object detection is a fundamental step in visual perception for various applications, including object classification.

Once the boundaries and locations of objects have been detected within an image, typically one or more classification methods or models may be used to identify the detected objects. That is, object classification is a computer vision task that involves assigning a predefined label or category to an object within an image. For object classification, the goal is to identify the type or class of the object present in the image based on its visual features. Common object classes may include people, vehicles, animals, buildings, and specific items like traffic signs. Classification models may be machine learning models that have been trained in a supervisory manner on labeled datasets, wherein each image is associated with the correct class labels (also referred to as the ground truth labels). During training, the model learns to associate visual patterns and features with specific object categories.

As noted above, object classification is particularly critical for autonomous driving applications. In autonomous driving, a vehicle might use object classification to identify whether a detected object is a pedestrian, a car, a bicycle, or another relevant category. However, there are some significant challenges related to image processing for autonomous driving. AD vehicles operate in diverse environments with dramatically different lighting conditions. These lighting conditions can affect the image processing. Furthermore, sensor data may receive captured image data in different bit depths or sizes. Changing between these bit depths can create image artifacts that can affect image processing applications for the AD system.

Given the extreme importance of image processing for the safe operation of an AD system, what is needed are systems and methods that can provide better image processing.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

Figure (“FIG.”) 1 is a block diagram illustrating a networked system, according to embodiments of the present disclosure.

FIG. 2 is a block diagram illustrating an example of an autonomous driving vehicle system, according to embodiments of the present disclosure.

FIGS. 3A & 3B are block diagrams illustrating an example of an autonomous driving system used with an autonomous driving vehicle, according to embodiments of the present disclosure.

FIG. 4 is a block diagram of an example control system, in accordance with aspects of the present disclosure.

FIG. 5 depicts a diagram of an example control system and associated inputs and outputs, according to embodiments of the present disclosure.

FIG. 6 graphically illustrates a conventional image data processing sequence, according to embodiments of the present disclosure.

FIG. 7 graphically illustrates a methodology for image processing, according to embodiments of the present disclosure.

FIG. 8 depicts a general methodology for image processing, according to embodiments of the present disclosure.

FIG. 9 provides an example of image data that has been processed according to an embodiment of the current patent document.

FIG. 10 provides another example of image data that has been processed according to an embodiment of the current patent document.

FIG. 11 graphically illustrates an alternative methodology for image processing, according to embodiments of the present disclosure.

FIG. 12 depicts the methodology for image processing corresponding to FIG. 11, according to embodiments of the present disclosure.

FIG. 13 graphically illustrates yet another alternative methodology for image processing, according to embodiments of the present disclosure.

FIG. 14 depicts the methodology for image processing corresponding to FIG. 13, according to embodiments of the present disclosure.

FIG. 15 depicts a simplified block diagram of a computing device, according to embodiments of the present disclosure.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures. Furthermore, one skilled in the art will recognize that embodiments of the present disclosure, described below, may be implemented in a variety of ways, such as a process, an apparatus, a system, a device, or a method on a tangible computer-readable/processor-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to a system component or components into which information may be entered or otherwise recorded. A set may contain any number of elements, including the empty set.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

It shall also be noted that although embodiments described herein may be within the context of autonomous driving (AD) computing systems, aspects of the present disclosure are not so limited. For example, the embodiments presented herein may be applied to systems that are not fully autonomous and may be applied in any application that requires reliable power. Accordingly, aspects of the present disclosure may be applied or adapted for use in other contexts.

### A. General Overview

An autonomous vehicle can navigate to various locations using onboard sensors, thereby allowing the vehicle to travel with little or no human interaction. A critical aspect of any vehicle, whether fully autonomous or not, is its computation operations. Most modern vehicles utilize some level of computation functions (e.g., antilock braking, efficient fuel control, transmission operation, safety monitoring (e.g., monitoring key components), etc.). For a vehicle to be safe, it must be able to properly rely upon these computation functions.

Among the most important systems for an autonomous driving vehicle are its imaging sensors and image processing systems. Without these systems the autonomous driving (AD) system cannot perceive the surrounding environment. Image detection and image classification are essential for the AD system to make real-time decisions to ensure safe and efficient navigation.

However, there are some significant challenges related to image processing for autonomous driving. AD vehicles operate in diverse environments with dramatically different lighting conditions. These lighting conditions can affect the image processing. Furthermore, sensor data may receive captured image data in different bit depths or sizes. Changing between these bit depths can create image artifacts that can affect image processing applications for the AD system.

Accordingly, presented herein are embodiments that improve the processing of image data, which can in turn improve the detection and recognition of objects such as traffic lights or any light source in autonomous driving applications. One skilled in the art shall recognize additional applications and advantages that are not enumerated here for the sake of brevity.

### B. Embodiments of an Autonomous Driving Vehicle

FIG. 1 is a block diagram illustrating an autonomous driving network configuration according to one or more embodiments of the present disclosure. Referring to FIG. 1, network configuration 100 includes autonomous driving vehicle (ADV) 101 that may be communicatively coupled to one or more servers 103-104 over a network 102. Although one ADV is shown, multiple ADVs may be coupled to each other and/or coupled to servers 103-104 over network 102. Network 102 may be any type of network, such as a local area network (LAN), a wide area network (WAN) such as the Internet, a cellular network, a satellite network, an edge network, or a combination thereof, and may comprise wired, wireless, or both connectivity. Server(s) 103-104 may be any kind of information handling system or a cluster of information handling systems, such as Web or cloud servers, application servers, backend servers, or a combination thereof. Servers 103-104 may be data analytics servers, content servers, traffic information servers, map and point of interest (MPOI) servers, location servers, etc.

An ADV refers to a vehicle that may be configured to operate in an autonomous mode in which the vehicle navigates through an environment with little or no input from a driver. Such an ADV may include a sensor system having one or more sensors that are configured to detect information about the environment in which the vehicle operates. The vehicle and its associated controller(s) may use the detected information to navigate through the environment. ADV 101 may operate in a manual mode, a fully autonomous mode, or a partially autonomous mode.

In one or more embodiments, ADV 101 includes, but is not limited to, an autonomous driving system (ADS) 110, vehicle control system 111, wireless communication system 112, user interface system 113, and sensor system 115. ADV 101 may further include certain common components included in ordinary vehicles, such as an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, wireless signals, or a combination thereof. For example, components 110-115 may be communicatively coupled to each other via a controller area network (CAN) bus or network connection. In one or more embodiments, a CAN bus is a vehicle bus standard designed to allow microcontrollers, devices, and applications to communicate with each other without a host computer; it is a message-based protocol, designed originally for multiplex electrical wiring within automobiles but may also be used in many other contexts.

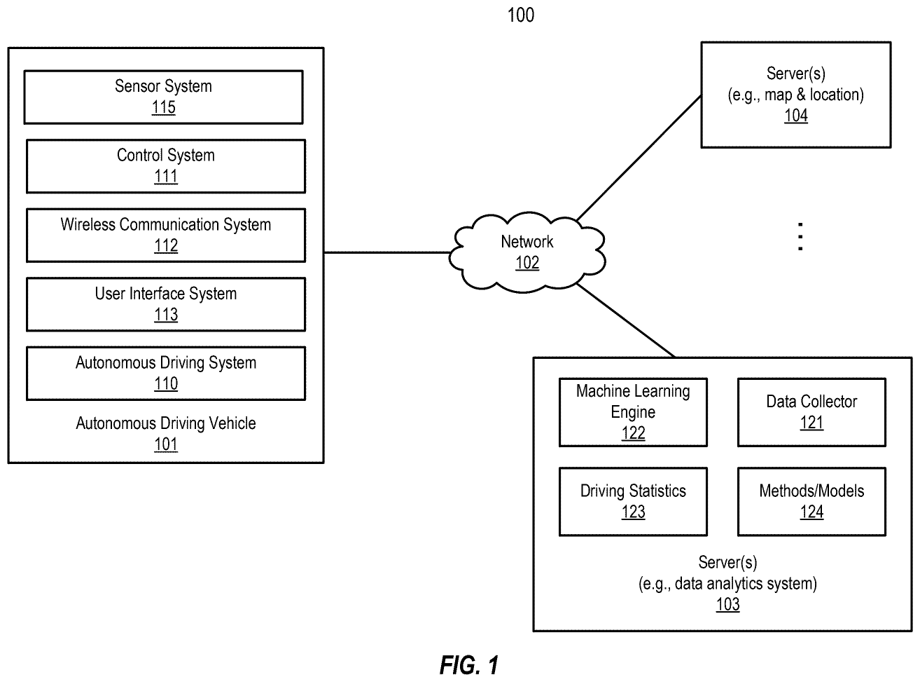

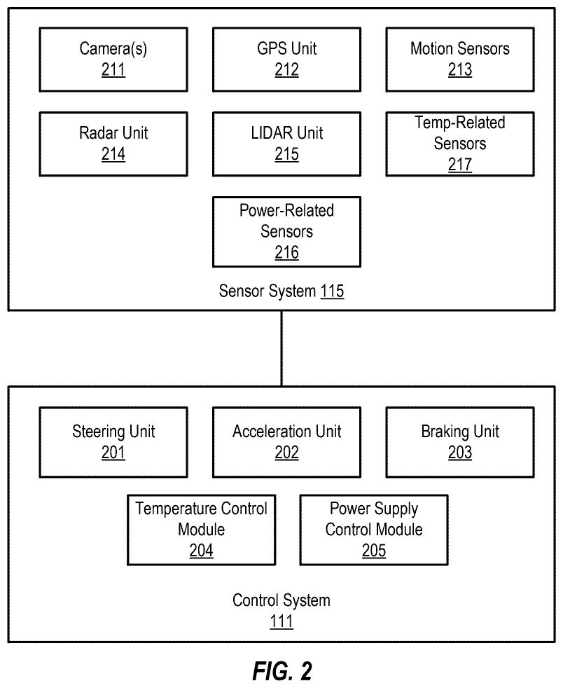

Referring now to FIG. 2, in one or more embodiments, the sensor system 115 includes, but is not limited to, one or more cameras 211, a global positioning system (GPS) unit or module 212, one or more motion sensors (e.g., inertial measurement unit (IMU), accelerometer, etc.) 213, radar unit 214, and a light detection and range (LIDAR) unit 215. GPS system 212 may include a transceiver operable to provide information regarding the position of the ADV. The motion sensor unit 213 may sense position and orientation changes of the ADV based on inertial acceleration. Radar unit 214 may represent a system that utilizes radio signals to sense objects within the local environment of the ADV. In one or more embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting platform.

Sensor system 115 may further include other sensors, such as a sonar sensor, an infrared sensor, a steering sensor, a throttle sensor, a braking sensor, an audio sensor (e.g., a microphone), and a weight or mass sensor. An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor. In one or more embodiments, one or more sensors may be used to determine the mass or weight of the ADV, including its occupants and any other payload. In one or more embodiments, the mass/weight may be determined using one or more factors, such as torque (e.g., wheel torque need to accelerate, braking torque needed to accelerate or decelerate, etc.). Having one or more mass/weight sensors to gauge the overall weight of the ADV and its contents (including occupants) allows the ADV to use mass and/or weight parameters for one or more determinations, such as braking, accelerating, handling, etc.

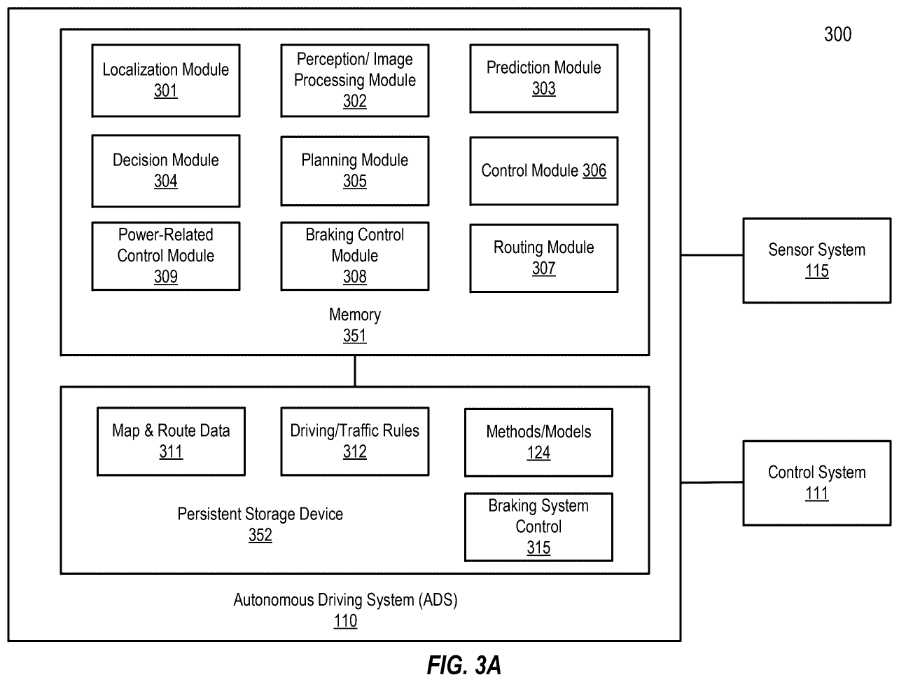

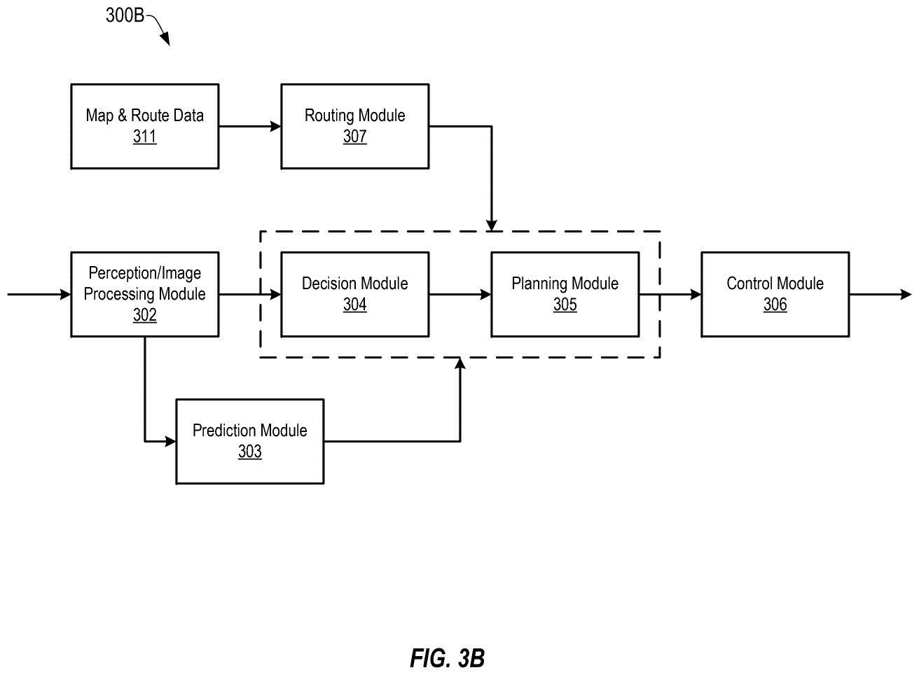

In one or more embodiments, vehicle control system 111 includes, but is not limited to, steering unit 201, throttle unit 202 (also referred to as an acceleration unit), and braking unit 203 (also referred to as the braking system 203). Steering unit 201 may be used to adjust the direction or heading of the vehicle. Throttle unit 202 may be used to control the speed of the motor or engine which in turn controls the speed and acceleration of the vehicle. Braking unit 203 may be used to decelerate the vehicle by providing friction to slow the wheels or tires of the vehicle. The steering unit 201, the acceleration unit 202, and the braking system 203 may be coupled, in part, with the AD control or AD system (e.g., ADS 110 in FIG. 3A).

Sensor system 115 may further include one or more sensors 217 related to temperature or cooling systems. For example, the temperature-related sensor(s) 217 may include one or more temperature sensors (e.g., thermocouples, thermometers, etc.). It shall be noted that one or more other temperature-related sensors may be present, such as pressure sensors. In one or more embodiments, data from one or more temperature-related sensors may be supplied to temperature control module 204, which may comprise one or more control systems or interfaces for affecting cooling or heating systems for the ADV. For example, the temperature control module 204 may monitor the temperature of a computing system on which the ADV systems (e.g., ADV 101) operate. As noted previously, maintaining the computing system within a certain operating temperature range can be important for the computing system to properly and timely operate. Also, since the vehicle may be fully autonomous, it is imperative that its computing abilities not be inhibited, take too long to process, or make erroneous calculations. Furthermore, keeping the computing system within a certain operational temperature range helps prolong the life of the computing components.

In one or more embodiments, the control system may also comprise a power supply control module 205 that controls one or more power systems of the ADV. Sensor system 115 may further include one or more sensors 216 related to power. For example, the power-related sensors 216 may include one or more battery monitor sensors—although it shall be noted that various types of power-related sensors intended to measure and monitor different aspects of electrical power systems may be used. Such power-related sensors may include, but are not limited to: voltage sensors, current sensors, power meters, power quality analyzers, residual current devices (RCD) (which detect and measure imbalances in current), voltage sag detectors (which monitor and detect short-term decreases in voltage), load sensors, and surge detectors.

Note that one or more of the components shown in FIG. 2 may be implemented in hardware, software, or a combination thereof.

Returning to FIG. 1, wireless communication system 112 is to allow communication between ADV 101 and external systems, such as devices, sensors, other vehicles, etc. For example, wireless communication system 112 may wirelessly communicate with one or more devices directly or via a communication network, such as servers 103-104 over network 102. Wireless communication system 112 may use any cellular communication network or a wireless local area network (WLAN), e.g., using WiFi to communicate with another component or system. Wireless communication system 112 may communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode, but may also provide functionality when operating in a manual mode or in a hybrid/assisted mode. ADS 110 includes hardware (e.g., processor(s), memory, storage, etc.) and software (e.g., operating system, planning and routing programs, etc.) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

A user as a passenger may specify a starting location and a destination of a trip, for example, via a user interface. ADS 110 obtains the trip-related data. For example, ADS 110 may obtain location and route data from an MPOI server, which may be a part of servers 103-104. The location server provides location services and the MPOI server provides map services and the POIs (points of interest) of certain locations. Additionally, or alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third-party entity. Additionally, or alternatively, the functionalities of servers 103-104 may be integrated with ADS 110. Based on the real-time traffic information, MPOI information, and location information, as well as real-time local environment data detected or sensed by the sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one or more embodiments, a data analytics system 103 includes a data collector 121 and a machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

In one or more embodiments, based on driving statistics 123, machine learning engine 122 generates or trains a set of rules, algorithms (methods), and/or predictive models 124 for a variety of purposes. For example, in one or more embodiments, methods/models 124 may include one or more algorithms or models to receive data from a plurality of sensors mounted on the ADV related to the ADV being held at or brought to a standstill, one or more methods for detecting a status of the ADV including a rolling speed of the ADV based on the data from the plurality of sensors, one or more methods to activate or deactivate one or more of the braking units (e.g., a primary brake and/or a secondary brake) in response to detecting the status of the ADV being at a particular status, which may be based upon one or more predetermined speed threshold ranges. Methods/models 124 may be uploaded on ADVs to be utilized during autonomous driving in real time.

FIGS. 3A and 3B are block diagrams illustrating an example of an autonomous driving system used with an ADV, according to embodiments of the present disclosure. System 300 may be implemented as a part of ADV 101 of FIG. 1 including, but is not limited to, ADS 110, control system 111, and sensor system 115. Referring to FIGS. 3A and 3B, ADS 110 includes, but is not limited to, localization module 301, perception/image processing module 302, prediction module 303, the decision module 304, planning module 305, control module 306, routing module 307, braking system control module 308, and power-related control module 309. It shall be noted that additional modules, while not depicted may be present, such as temperature control. Referring to FIG. 3B, planning module 305, control module 306, and/or other modules may perform the computations, determinations, and steps required to instruct the operation of systems of the vehicle.

Some or all of modules 301-309 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-309 may be integrated together as an integrated module.

Localization module 301 may determine a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as a map and route data 311, to obtain the trip-related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception may include the lane configuration, traffic light signals, a relative position of another vehicle, a pedestrian, a building, a crosswalk, or other traffic-related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module/image processing module 302 may include a computer vision system or functionalities of a computer vision system to process and analyze images captured by one or more cameras to identify objects and/or features in the environment of the ADV. The objects may include traffic signals, roadway boundaries, other vehicles, pedestrians, and/or obstacles, etc. The computer vision system may use object recognition methods, video tracking, and other computer vision techniques. In one or more embodiments, the computer vision system maps an environment, tracks objects, and estimates the speed of objects, etc. Perception module/image processing module 302 may also detect objects based on other sensor data provided by other sensors such as a radar and/or LIDAR.

For each of the objects, prediction module 303 predicts how the object will behave under the circumstances. The prediction may be performed based on the perception data perceiving the driving environment at the point in time given a set of map/route information 311, traffic rules 312, and/or braking system control parameters 315. For example, if the object is a vehicle in an opposing direction and the current driving environment includes an intersection, prediction module 303 may predict whether the vehicle is likely to move straight forward or make a turn. If the perception data indicates that the intersection has no traffic light, prediction module 303 may predict that the vehicle may have to fully stop before entering the intersection. If the perception data indicates that the vehicle is currently at a left-turn-only lane or a right-turn-only lane, prediction module 303 may predict that the vehicle is more likely to make a left turn or right turn, respectively.

The prediction module 303 may calculate a rate of deceleration or stop distance based on the braking system control parameters 315 to determine a safe zone for driving at a desired speed. For example, some obstacles/vehicles, road conditions, and/or safety conditions (e.g., open door) may cause the prediction module 303 to steer or decelerate to maintain safety. The braking control parameters 315 may include recorded deceleration data indicating an upper limit and/or environment-correlated deceleration rates. In one or more embodiments, the braking system control parameters 315 may be used by one or more braking systems (e.g., PBS, SBS, electric parking brake (EPB), etc.).

For each of the objects, decision module 304 may make a decision regarding how to handle the object. For example, for a particular object (e.g., another vehicle in a crossing route) as well as its metadata describing the object (e.g., a speed, direction, turning angle, etc.), decision module 304 may decide how to encounter the object (e.g., overtake, yield, stop, pass, etc.). Decision module 304 may make such decisions according to a set of rules, such as traffic rules or driving rules 312, which may be stored in persistent storage device 352.

In one or more embodiments, routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in the form of a topographic map for each of the routes it determines from the starting location to reach the destination location. A reference line refers to an ideal route or path without any interference from others such as other vehicles, obstacles, or traffic conditions. That is, if there is no other vehicle, pedestrians, or obstacles on the road, an ADV should exactly or closely follow the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 depending upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, the decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 300 would move in a next moving cycle (e.g., next route/path segment). For example, the planning and control data may instruct vehicle 300 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. In one or more embodiments, the planning and control data include sufficient information to drive the vehicle from a first point to a second point of a route or path using appropriate vehicle settings or driving parameters (e.g., throttle, braking, steering commands, etc.) at different points in time along the path or route.

In one or more embodiments, the planning phase is performed in a number of planning cycles, also referred to as driving cycles, such as, for example, in every time interval of 100 milliseconds (ms). For each of the planning cycles or driving cycles, one or more control commands may be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one or more embodiments, planning module 305 plans a route segment or path segment for the next predetermined period of time such as 5 seconds. For each planning cycle, planning module 305 plans a target position for the current cycle (e.g., the next 5 seconds) based on a target position planned in a previous cycle. Control module 306 may then generate one or more control commands (e.g., throttle, brake, steering control commands, etc.) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect the movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system may incorporate data from a GPS system and one or more maps to determine the driving path for the ADV.

While not depicted in FIG. 3A, a temperature control module may receive one or more measurements related to temperature for controlling systems that operate within certain temperature ranges. In one or more embodiments, the temperature-related control module may receive temperature readings of the computing system of the ADV. To keep the computing system within an operational temperature range, the temperature-related control module may control a cooling system.

Also depicted in FIG. 3A is a power-related control module 309 that may receive one or more measurements related to power (e.g., generator, batteries, solar, etc.) for systems. In one or more embodiments, the power-related control module 309 may receive power-related readings from various power sources and at various junctions. To keep the computing systems operational, the power-related control module 309 may control which source(s) provides power (e.g., main power, primary backup, secondary backup, tertiary backup, etc.) and which components or systems receive power. Embodiments are disclosed in more detail below.

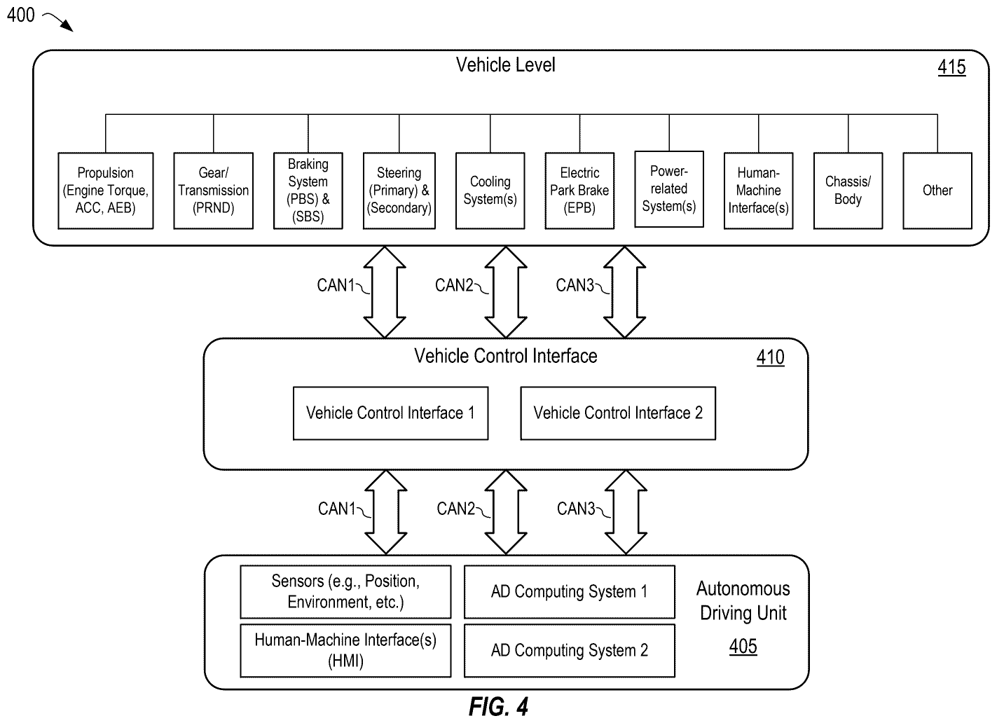

FIG. 4 is a block diagram 400 of an example control system, in accordance with aspects of the present disclosure. As shown, the example control system may include three high-level components: the autonomous driving unit 405, the vehicle control interface 410, and the vehicle level components 415.

The autonomous driving unit 405 may include various sensors (e.g., cameras, microphones, LIDAR, GPS, accelerometers, door sensors, light sensors, proximity sensors, thermal sensors, tilt sensors, hydraulic pressure sensors, brake caliper sensors, power-related sensors, etc.). The autonomous driving unit may include one or more autonomous driving computer systems for computing control inputs to the vehicle-level components (e.g., engine, braking system, steering, etc.).

The vehicle control interface 410 allows the sensor information to be provided to the various vehicle-level components 415. For example, a command/output from the AD computer system may be used to actuate two or more components (e.g., steering, brake, cooling, etc.) at the vehicle level. According to aspects of the present disclosure, power control may be implemented using sensors, the power-related system(s), and one or more computing systems.

In one or more embodiments, the vehicle-level elements may include propulsion-related components (or elements), gear/transmission-related components, steering, braking, interfacing, chassis/body, cooling system(s), and other elements (e.g., tire pressure sensors and controls). While these vehicle-level components are depicted as being connected or communicatively connected via a single connection, there may be one or more redundant connections; there may also be differently configured connections (i.e., certain components may be on different connection segments than other components). The vehicle-level components may include various sensors for providing feedback to the respective operations.

In one or more embodiments, the vehicle-level system may include cooling systems for maintaining one or more components (e.g., engine, computing system, etc.) within an operational temperature range for the respective component. Different cooling systems may be used for different components. For example, if the vehicle includes an engine that requires cooling, the cooling system for the engine may be separate from a cooling system for the computing system. In one or more embodiments, one or more elements of the cooling system may be used in common between cooling systems.

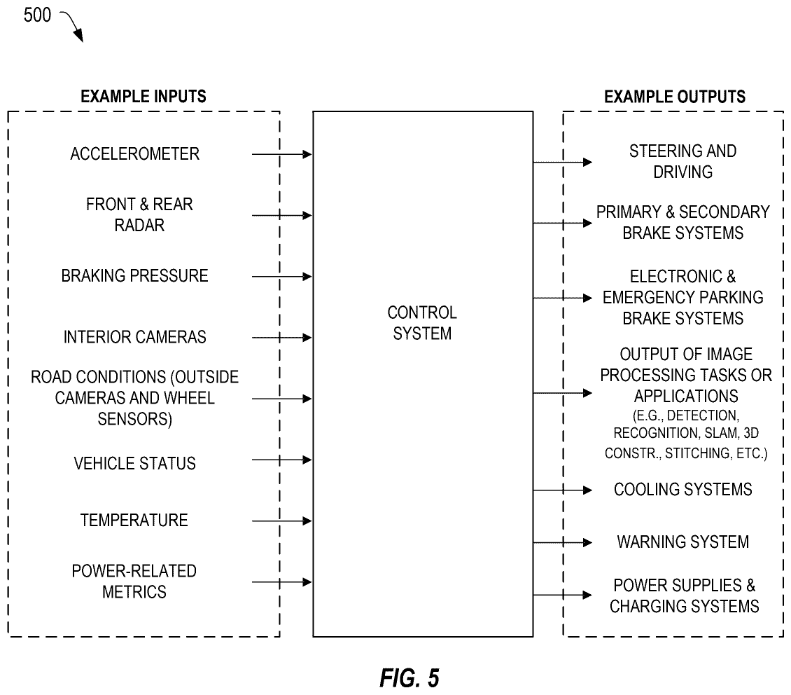

FIG. 5 depicts a diagram 500 of an example control system and associated inputs and outputs, according to embodiments of the present disclosure. As shown, the control system may use various measurements or sensor feedback as input. The example inputs may include information (e.g., speed) from one or more accelerometers, braking pressure valves, hydraulic pressure, brake caliber valves, radar (or LIDAR) information of the front and rear of the ADV, imaging information from interior cameras, road conditions captured by exterior cameras and/or wheel sensors, door sensors, vehicle status (e.g., speed, operation conditions of various systems, such as whether one or more of the braking systems are operating properly, etc.), temperature, and pressure of coolant system, and power-related metrics. While not depicted, in one or more embodiments, the control system may receive one or more failure messages related to conditions of a critical component, such as the power systems and computing systems.

Upon determining a status based upon one or more sensor inputs or messages, the control system may provide various outputs to various systems of the ADV. For example, outputs may include control signals to control power source(s) to one or more computing systems, vehicle control, and alerts and warning systems, among others, for handling power control for the ADV.

In one or more embodiments, one or more wheel sensors may be used to detect the speed of the ADV. The wheel sensors may generate magnetic pulses in the form of waves, proportional to the speed of the ADV. For example, one or more of the ADV's wheel sensors, which may be located at each of the wheels (i.e., front left (FL), front right (FR), rear left (RL), rear right (RR) wheel), may be used to detect the speed of the ADV based on pulses detected. In one or more embodiments, when at least two diagonal wheel sensors (e.g., FL & RR or FR & RL) detect pulses within a set time period, the control system may register a status or state of the ADV. The ADV may be in different states based on the speed of the ADV, and different control techniques may be applied accordingly.

Different actions may be activated or triggered based on different states of the ADV. It shall also be noted that one or more different conditions may be monitored and/or may be combined to form a detected state.

In one or more embodiments, the control system may receive power/battery monitoring information related to one or more power systems and may take action to control the powering of components in the vehicle and for executing one or more actions.

Note that at least some of the components described above may be implemented in software, hardware, or a combination thereof. For example, such components can be implemented as software installed and stored in a persistent storage device, which can be loaded and executed in memory by a processor (not shown) to carry out the processes or operations described throughout this application. Alternatively, such components can be implemented as executable code programmed or embedded into dedicated hardware such as an integrated circuit (e.g., an application-specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the detailed descriptions presented herein are presented in terms of methods and symbolic representations of operations on data bits within a computer memory. These descriptions and representations are the ways used by those skilled in the data processing arts to most effectively convey the substance of their work to others skilled in the art. A method may, generally, be conceived to be a self-consistent sequence of operations leading to a desired result or results; the operations may be considered to be those requiring physical manipulations of physical quantities.

It should be borne in mind, however, that these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### C. Image Processing Embodiments

Typically, image sensors for autonomous driving support HDR (High Dynamic Range) scenes. HDR scenes are usually represented by a data bit depth of 24 bits per channel (e.g., per color pixel).

After receiving the input image data from an image sensor, the raw data typically undergoes several steps of signal processing to generate an image of better image quality. Also, the data bit depth of the image is reduced. For example, the image is often reduced to 8 bits per channel because this is a common data range for image processing and for displays.

There is a process for generating an 8-bit depth image from a higher bit depth image (e.g., an HDR image), which is known as tone mapping. Tone mapping helps make an HDR image look suitable from a human-eye perspective. Tone mapping adjusts the tonal range of an image or scene, which is particularly useful when dealing with high dynamic range (HDR) images that contain a wide range of light intensity values, from very bright to very dark.

Simply put, tone mapping is a process of compressing or remapping the tonal values of an image so that they can be displayed on a device that has a more limited dynamic range, such as computer monitors or printed material. A goal is to retain as much detail as possible in both the highlight and shadow areas of the image, thereby making it visually appealing and perceptually realistic. However, a tone-mapping process usually generates artifacts in the resultant image. The artifacts include, but are not limited to, color artifacts and gradient brightness of light sources.

Embodiments herein include methodologies for directly using x bits from high bit depth image data to skip the tone-mapping process. Such approaches improve the detection and recognition of bright objects, such as traffic lights or any light source, which is particularly useful in autonomous driving applications.

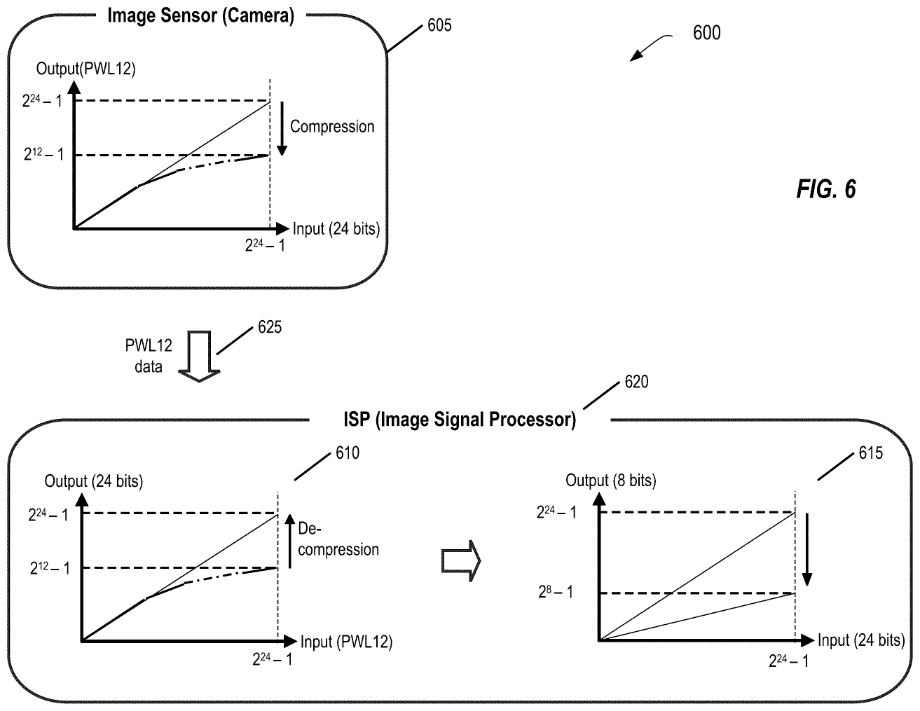

FIG. 6 graphically illustrates a conventional image data processing sequence, according to embodiments of the present disclosure. In the depicted example, one channel of an image data is represented, which has a maximum possible value of 224-1 and a minimum possible value of zero (0). In this example, the larger data values represent higher light intensity objects. It shall be noted that different sizes of bit depth may be used and different configurations of the data representation may be used (e.g., low data values may represent bright object and high data values may represent dark objects).

As illustrated, input sensor data 605 of the input image from a camera or other type of imaging sensor may undergo a data compression process before being sent to an image signal processor or processors (ISP) 620. An example compression method is a piecewise linearization (PWL12), which is a lossless compression that reduces the image data from its original bit depth size to a bit depth size of twelve (12) bits. One reason for compressing the data is because it can be difficult to send the imaging sensor data directly to the ISP as it consumes a lot of computation resources (e.g., bandwidth). By compressing the data, less bandwidth 625 and other computation resources are needed to transmit the data to the ISP 620.

Once at the ISP, decompression 610 (e.g., the image is returned to its original 24 bits per channel) and linearization of the input compressed data (PWL12) may be performed. This data may then undergo a number of image signal processes. For example, the image may be demosaiced, color correction using a color correction matrix (CCM), gamma correction, tone mapping, among other possible image processes. As noted above, a tone mapping feature is used to generate a reduced bit-depth representation of the image (e.g., 8-bit data per channel from 24-bit data per channel). A final red-green-blue (RGB) output per pixel (or some other representation such as YUV) may be generated.

There are advantages to such a process. First, tone mapping is good for human perception of a high dynamic range scene. Second, it effectively maps the data from a high dynamic range (e.g., 24-bit data) to a lower bit depth (e.g., 8-bit data) range. Finally, an image can include a wide range of information from very dark to very bright objects or scenes.

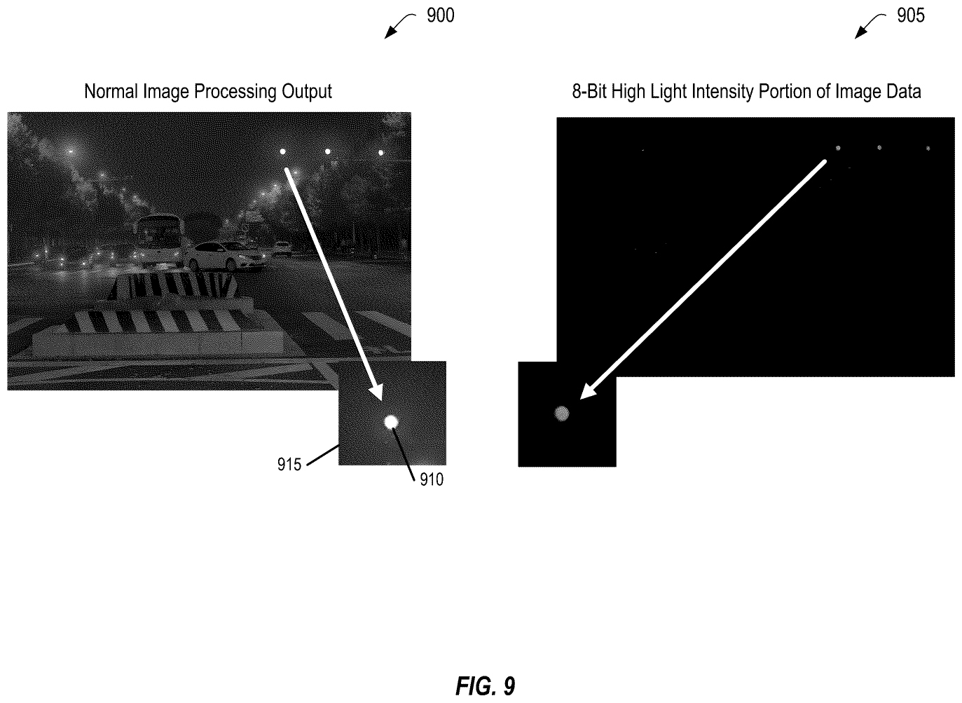

However, such processing is not without disadvantages. During the image processing, RGB ratio may be changed, which causes color artifacts. For example, original colors may be shifted to different colors. If color is an important feature for a downstream image process such as object classification (e.g., detecting whether a traffic signal is red or green), this color shift may cause significant issues. FIG. 9 depicts an image 900 that has been processed in a conventional manner. Note that the red stop light following image processing is shifted to white at its core 910.

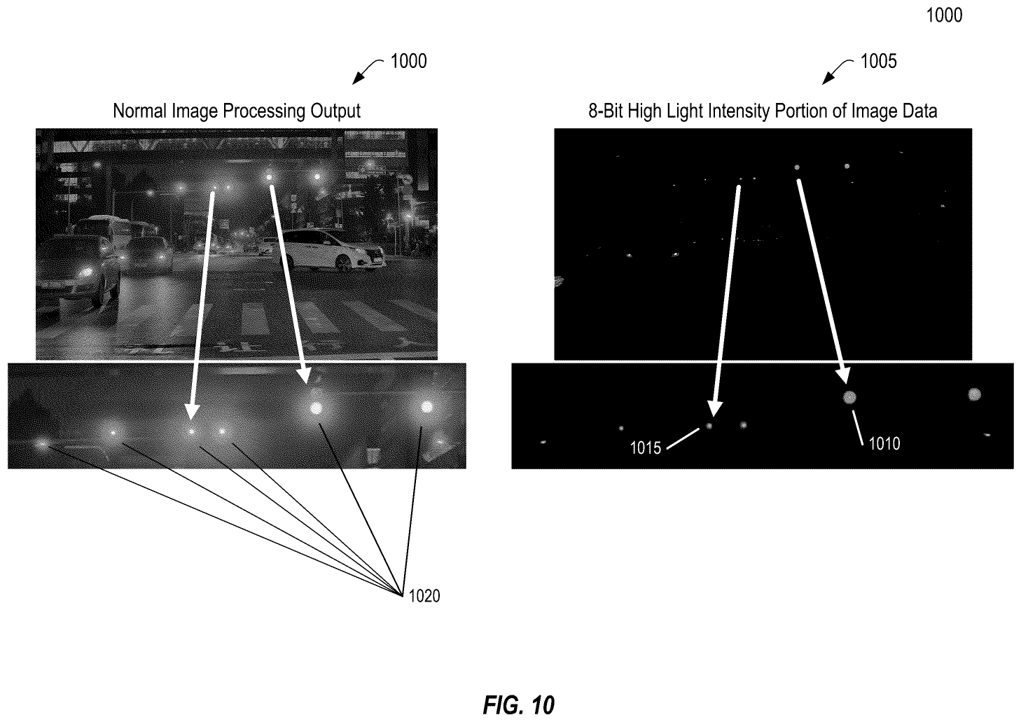

Also, for bright light sources, a halo effect (i.e., a gradient light variation) or saturation in normal signal processing, is created. The halo effect makes a naturally appealing image for human perception, but it creates problems for other image processes, such as object recognition. The diffused boundaries created by the halo effect make it difficult to define discrete boundaries of objects. Returning to the image 900 in FIG. 9 that has been processed in a conventional manner, note that a halo 915 is formed around the red stop light. The halo effect 1020 is even more pronounced in image 1000 of FIG. 10. The halo effect makes it more difficult to define a boundary for the traffic light.

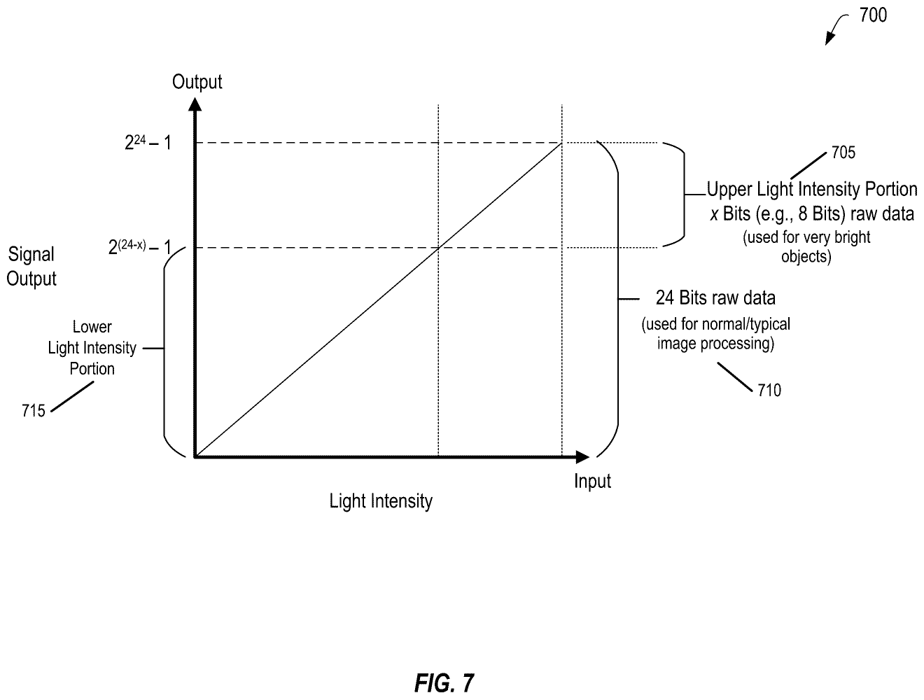

FIG. 7 graphically illustrates a methodology 700 for image processing, according to embodiments of the present disclosure. In one or more embodiments, after decompression of the input image to its original bit depth (e.g., 24 bits per channel), a portion of the image data—the top x-bit range (e.g., 8 bits) 705, which corresponds to the high light intensity data of the input image, may be selected to be used for bright object detection. In one or more embodiments, the full set of image data (e.g., 24 bits) may be used for typical image processing. It shall be noted that what is typical/conventional may vary depending upon the application. In the case of autonomous driving, image processes may include a simultaneous localization and mapping (SLAM) process, object detection, classification, distortion correction, cropping, stitching, depth extraction, 3D construction, among other processes.

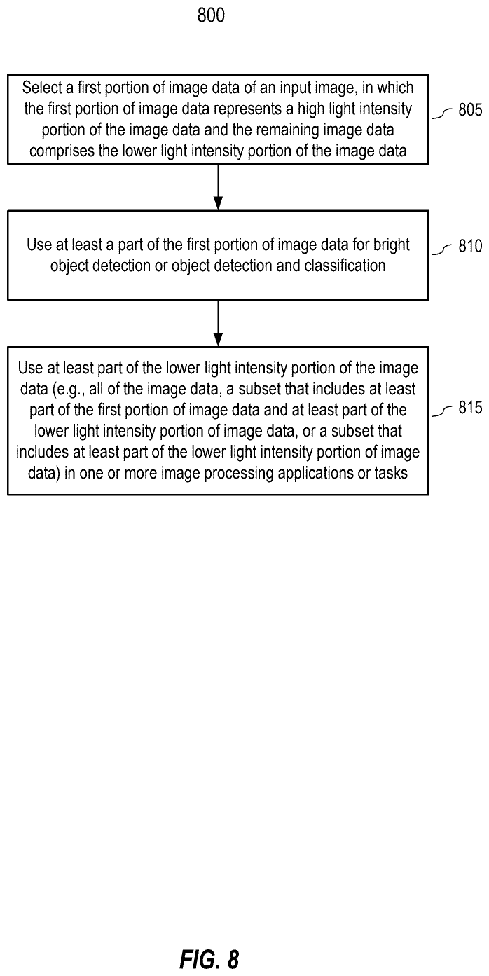

FIG. 8 depicts a general methodology for image processing, according to embodiments of the present disclosure. In one or more embodiments, a first portion of image data of an input image is selected (805), in which the first portion (e.g., 705 in FIG. 7) of image data represents a high light intensity portion of the image data and the remaining image data (e.g., 715 in FIG. 7) comprises the lower light intensity portion of the image data 710. The first portion may be defined by having a set bit depth range (e.g., top 8 bits).

In one or more embodiments, at least a part of the first portion 705 of the image data may be used (810) for bright object detection or object detection and classification. Note that “at least part of the first portion” may be used because one or more pre-processing steps may be performed prior to (or as part of) the object detection or classification processes. For example, part of the image may be cropped thereby removing part of the first portion, filtering may remove part of the first portion, or some other process or processes that result in removal of part of the first portion may be performed.

In one or more embodiments, at least part of the lower light intensity portion 715 of the image data may be used (815) in one or more image processing tasks or applications. In like manner as discussed above, note that “at least part of the lower light intensity portion” may be used because one or more pre-processing steps may be performed that remove part of the lower light intensity portion. Note also that the phrase “at least part of the lower light intensity portion” comprises or encompasses several different embodiments. Each of the following includes “at least part of the lower light intensity portion”: (1) a part (or subset) of the lower light intensity portion; (2) all of the lower light intensity portion; (3) any other portion of the image data that is combined with either (1) or (2) (e.g., all of the image data, a subset that includes at least part of the first portion of image data and at least part of the lower light intensity portion of image data, etc.).

It shall be noted that embodiments provide at least a couple advantages. First, when there is a bright object in the image data (e.g., a light source such as a traffic light), there is no halo or color artifact because it is operating on data that has not been tone mapped. Second, the normal/typical image processing may be used for other applications or tasks, such as a SLAM feature of the bright object detection.

FIG. 9 provides an example of image data that has been processed according to an embodiment of the current patent document. Image 900 has been processed as is typically done, including tone mapping. Note that, for the traffic lights, there is a halo effect (e.g., halo 915) due to the compression and that the traffic lights have color artifacts so that the red traffic light at its core appears white (e.g., traffic light 910) due to saturation. By way of comparison, the top 8 bits of high light intensity data for the same image shows that there is not a halo effect, and the red color is maintained. The absence of the halo improves object detection because the boundary of the traffic light is more clearly defined. Also, because the boundary is clear and because the color is more accurate, object classification performed on the image is able to be more accurate. That is, a classification model is more likely to accurately classify the light as a red traffic light.

FIG. 10 provides another example of image data that has been processed according to an embodiment of the current patent document. Note that because the color has not been altered (or not significantly altered) in the 8-bit high light intensity portion 1005 of the image data, the green traffic light 1010 remains green in color. Thus, it can be distinguished (e.g., using a classification model) from a white/off-white security light 1015. By way of contrast, in the normal image processing output image 1000, it is more difficult to distinguish by color between the green traffic light and the white/off-white security light.

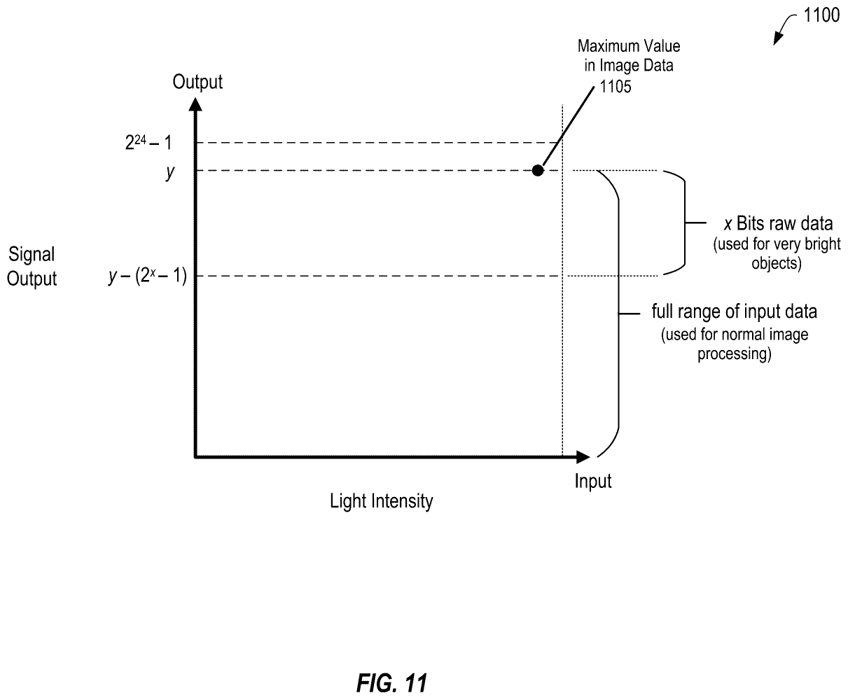

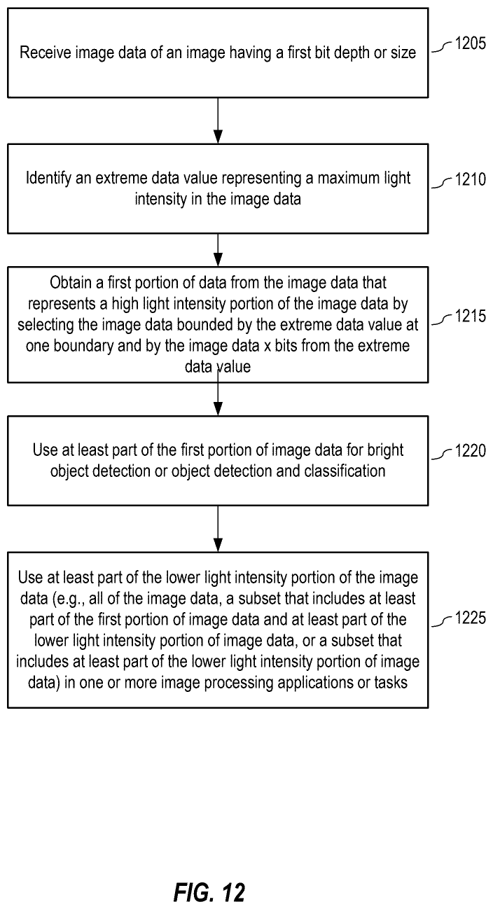

FIG. 11 graphically illustrates an alternative methodology for image processing, according to embodiments of the present disclosure, and FIG. 12 depicts the methodology for image processing corresponding to FIG. 11, according to embodiments of the present disclosure.

Given (1205) image data of an image having a first bit depth or size, an extreme data value (data point 1105 in FIG. 11) representing a maximum light intensity in the image data is identified (1210). Unlike the embodiment depicted in FIG. 7 in which the top boundary of the first portion was the upper limit value of the bit depth, here the top boundary is the maximum data value in the input image. It should be noted that in this example, higher values represent brighter objects. If the light intensity representation is inverted such that bright objects have lower data values, then a minimum data value of the input image would be selected to be one of the boundaries of the bit range of the first portion of image data.

Having set a boundary, a first portion of data from the image data that represents a high light intensity portion of the image data may be obtained by selecting (1215) the image data bounded by the extreme data value at one boundary and by the image data x bits (e.g., 8 bits) from the extreme data value.

As with the method discussed in relation to FIG. 8, in one or more embodiments, at least part of the first portion of image data may be used (1220) for bright object detection or object detection and classification, and at least part of the lower light intensity portion of the image data may be used (1225) in one or more image processing applications or tasks.

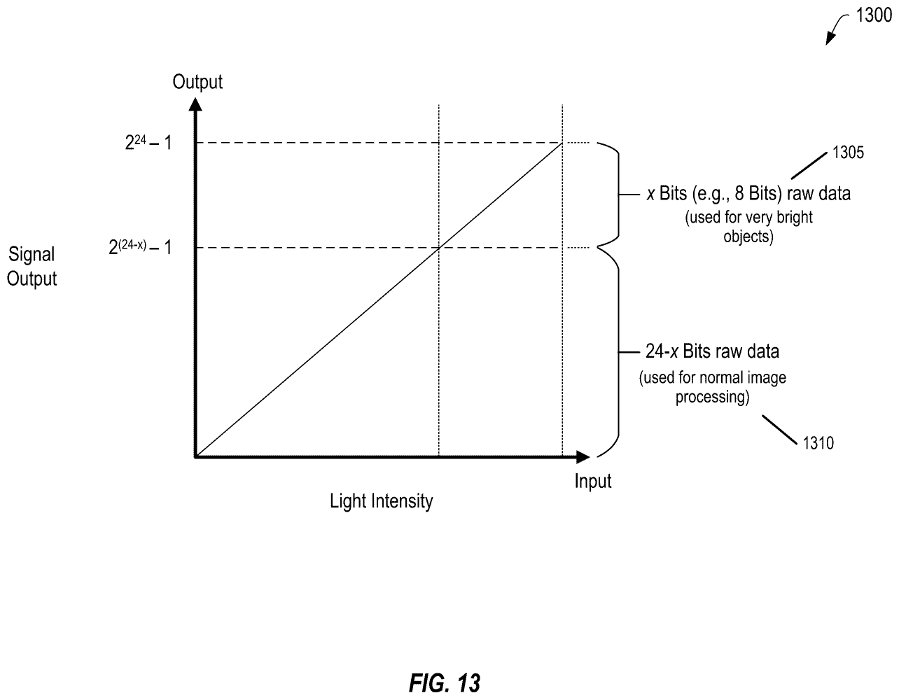

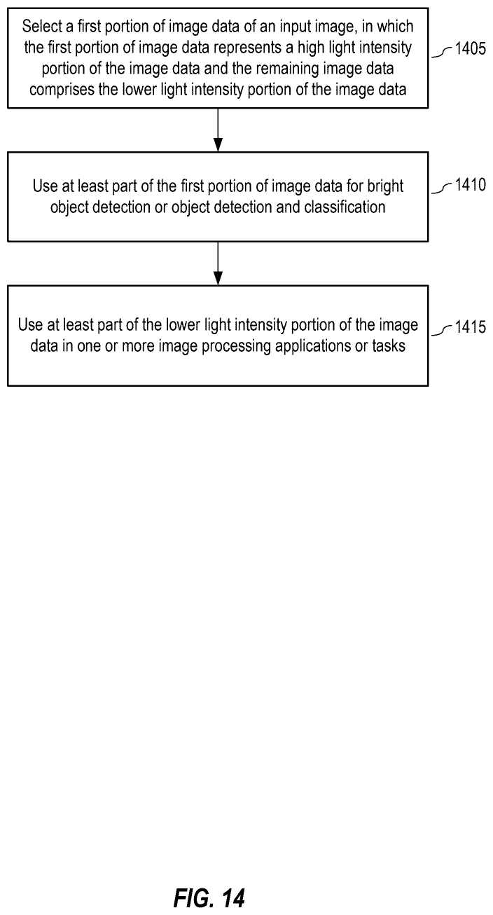

FIG. 13 graphically illustrates yet another alternative methodology for image processing, according to embodiments of the present disclosure, and FIG. 14 depicts the methodology for image processing corresponding to FIG. 13, according to embodiments of the present disclosure.

Given image data of an image having a first bit depth or size, a first portion 1310 of data from the image data that represents a high light intensity portion of the image data may be obtained by selecting (1405) the image data bounded by an extreme value at one boundary and by the image data x bits (e.g., 8 bits) from the extreme value. The extreme value may be the maximum possible value allowed by the data representation (as illustrated in FIG. 13) or it may be the extreme data value in the image data as discussed in relation to FIGS. 11 and 12. In either event, a first portion of image data of the input image is selected that represents the high light intensity portion of the image data and the remaining image data comprises the lower light intensity portion 1310 of the image data.

In a similar manner as described previously, in one or more embodiments, at least part of the first portion of image data may be used (1410) for bright object detection or object detection and classification, and at least part of the lower light intensity portion 1310 of the image data may be used (1415) in one or more image processing applications or tasks.

It shall be noted that the embodiments herein may be performed per channel. In one or more embodiments, the same methodologies and portion sizes may be used for different channels. Alternatively, different methodologies and/or different sized portions may be used for different channels. It shall be noted that a monochrome image may comprise a single channel and that one or more of the embodiments herein may still be used.

In one or more embodiments, the channels may be combined to generate a resultant or final image.

### D. Computing System Embodiments

In one or more embodiments, aspects of the present patent document may be directed to, may include, or may be implemented on or use one or more computing systems. An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a specialized processor-enabled computing system, a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read-only memory (ROM), and/or other types of memory. Additional components of the computing system may include one or more drives (e.g., hard disk drive, solid-state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

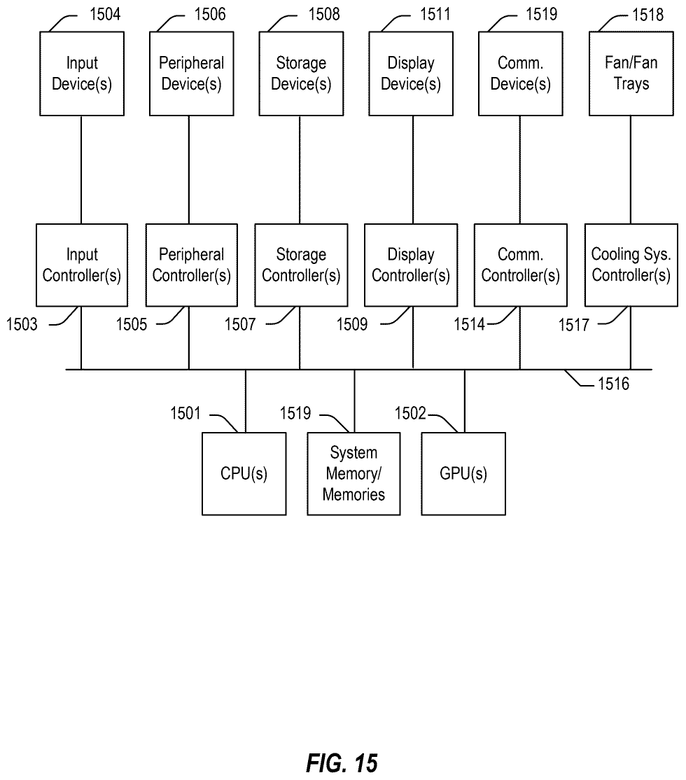

FIG. 15 depicts a simplified block diagram of an information handling system (or computing system), according to embodiments of the present disclosure. It will be understood that the functionalities shown for system 1500 may operate to support various embodiments of a computing system—although it shall be understood that a computing system may be differently configured and include different components, including having fewer or more components as depicted in FIG. 15.

As illustrated in FIG. 15, the computing system 1500 includes one or more CPUs 1501 that provide computing resources and control the computer. CPU 1501 may be implemented with a microprocessor or the like, and may also include one or more graphics processing units (GPU) 1502 and/or a floating-point coprocessor for mathematical computations. In one or more embodiments, one or more GPUs 1502 may be incorporated within the display controller 1509, such as part of a graphics card or cards. The system 1500 may also include a system memory 1519, which may comprise RAM, ROM, or both.

A number of controllers and peripheral devices may also be provided, as shown in FIG. 15. An input controller 1503 represents an interface to various input device(s) 1504. The computing system 1500 may also include a storage controller 1507 for interfacing with one or more storage devices 1508 each of which includes a storage medium such as magnetic tape or disk, or an optical medium that might be used to record programs of instructions for operating systems, utilities, and applications, which may include embodiments of programs that implement various aspects of the present disclosure. Storage device(s) 1508 may also be used to store processed data or data to be processed in accordance with the disclosure. The system 1500 may also include a display controller 1509 for providing an interface to a display device 1511, which may be a cathode ray tube (CRT) display, a thin film transistor (TFT) display, organic light-emitting diode, electroluminescent panel, plasma panel, or any other type of display. The computing system 1500 may also include one or more peripheral controllers or interfaces 1505 for one or more peripherals 1506. Examples of peripherals may include one or more printers, scanners, input devices, output devices, sensors, and the like. A communications controller 1514 may interface with one or more communication devices 1515, which enables the system 1500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1500 comprises one or more fans or fan trays 1518 and a cooling subsystem controller or controllers 1517 that monitors thermal temperature(s) of the system 1500 (or components thereof) and operates the fans/fan trays 1518 to help regulate the temperature.

In the illustrated system, all major system components may connect to a bus 1516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented/processor-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher-level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

Note that some or all of the components as shown and described above may be implemented in software, hardware, or a combination thereof. For example, such components can be implemented as software installed and stored in a persistent storage device, which can be loaded and executed in a memory by a processor to carry out the processes or operations described throughout this application. Alternatively, such components can be implemented as executable code programmed or embedded into dedicated hardware such as an integrated circuit (e.g., an application-specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer-readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer-readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations. The specification and drawings are, accordingly, to be regarded in an illustrative sense rather than a restrictive sense.

What is claimed is:

1. A computer-implemented method for image processing comprising:
selecting a first portion of image data of an input image, in which the first portion of image data represents a high light intensity portion of the image data and the remaining image data comprises a lower light intensity portion of the image data;
using at least a part of the first portion of image data for bright object detection or object detection and classification in the input image; and
using at least part of the lower light intensity portion of the image data in one or more image processing applications or tasks.

2. The computer-implemented method of claim 1 wherein the first portion of image data of an input image comprises:
selecting data within a bit range of the image data, in which one boundary of the bit range corresponds to a maximum or minimum.

3. The computer-implemented method of claim 2 wherein the step of selecting data within a bit range of the image data, in which one boundary of the bit range corresponds to a maximum or minimum comprises:
given that the image data is represented by a bit depth defined by an upper limit value and a lower limit value, selecting the upper limit value or the lower limit value of the bit depth as the maximum or the minimum that defines one of the boundaries of the bit range of the first portion of image data.

4. The computer-implemented method of claim 2 wherein the step of selecting data within a bit range of the image data, in which one boundary of the bit range corresponds to a maximum or minimum comprises:
selecting a maximum data value or a minimum data value of the input image as the maximum or the minimum that defines one of the boundaries of the bit range of the first portion of image data.

5. The computer-implemented method of claim 1 wherein the step of using at least part of the lower light intensity portion of the image data in one or more image processing applications comprises:
using all of the image data in one or more image processing applications.

6. The computer-implemented method of claim 1 wherein the step of using at least part of the lower light intensity portion of the image data in one or more image processing applications comprises:
using at least part of the lower light intensity portion of image data but none of the first portion of image data in one or more image processing applications.

7. The computer-implemented method of claim 1 wherein at least one of the one or more image processing applications or tasks comprises at least one of:
a simultaneous localization and mapping (SLAM) process;
an object detection and classification process;
distortion correction;
cropping;
stitching;
depth extraction; and
three-dimensional (3D) construction.

8. The computer-implemented method of claim 1 wherein the image data represents one channel of the input image and a first portion is selected for each channel of the input image.

9. A system comprising:
one or more processors; and
a non-transitory computer-readable medium or media comprising one or more sets of instructions which, when executed by at least one of the one or more processors, causes steps to be performed comprising:
selecting a first portion of image data of an input image, in which the first portion of image data represents a high light intensity portion of the image data and the remaining image data comprises a lower light intensity portion of the image data;
using at least a part of the first portion of image data for bright object detection or object detection and classification in the input image; and
using at least part of the lower light intensity portion of the image data in one or more image processing applications or tasks.

10. The system of claim 9 wherein the first portion of image data of an input image comprises:
selecting data within a bit range of the image data, in which one boundary of the bit range corresponds to a maximum or minimum.

11. The system of claim 10 wherein the step of selecting data within a bit range of the image data, in which one boundary of the bit range corresponds to a maximum or minimum comprises:
given that the image data is represented by a bit depth defined by an upper limit value and a lower limit value, selecting the upper limit value or the lower limit value of the bit depth as the maximum or the minimum that defines one of the boundaries of the bit range of the first portion of image data.

12. The system of claim 10 wherein the step of selecting data within a bit range of the image data, in which one boundary of the bit range corresponds to a maximum or minimum comprises:
selecting a maximum data value or a minimum data value of the input image as the maximum or the minimum that defines one of the boundaries of the bit range of the first portion of image data.

13. The system of claim 9 wherein the step of using at least part of the lower light intensity portion of the image data in one or more image processing applications comprises:
using all of the image data in one or more image processing applications.

14. The system of claim 9 wherein the step of using at least part of the lower light intensity portion of the image data in one or more image processing applications comprises:
using at least part of the lower light intensity portion of image data but none of the first portion of image data in one or more image processing applications.

15. The system of claim 9 wherein at least one of the one or more image processing applications or tasks comprises at least one of:
a simultaneous localization and mapping (SLAM) process;
an object detection and classification process;
distortion correction;
cropping;
stitching;
depth extraction; and
three-dimensional (3D) construction.

16. A non-transitory computer-readable medium or media comprising one or more sequences of instructions which, when executed by at least one processor, causes steps to be performed comprising:
selecting a first portion of image data of an input image, in which the first portion of image data represents a high light intensity portion of the image data and the remaining image data comprises a lower light intensity portion of the image data;
using at least a part of the first portion of image data for bright object detection or object detection and classification in the input image; and
using at least part of the lower light intensity portion of the image data in one or more image processing applications or tasks.

17. The non-transitory computer-readable medium or media of claim 16 wherein the first portion of image data of an input image comprises:
selecting data within a bit range of the image data, in which one boundary of the bit range corresponds to a maximum or minimum.

18. The non-transitory computer-readable medium or media of claim 17 wherein the step of selecting data within a bit range of the image data, in which one boundary of the bit range corresponds to a maximum or minimum comprises:
given that the image data is represented by a bit depth defined by an upper limit value and a lower limit value, selecting the upper limit value or the lower limit value of the bit depth as the maximum or the minimum that defines one of the boundaries of the bit range of the first portion of image data.

19. The non-transitory computer-readable medium or media of claim 17 wherein the step of selecting data within a bit range of the image data, in which one boundary of the bit range corresponds to a maximum or minimum comprises:
selecting a maximum data value or a minimum data value of the input image as the maximum or the minimum that defines one of the boundaries of the bit range of the first portion of image data.

20. The non-transitory computer-readable medium or media of claim 16 wherein the step of using at least part of the lower light intensity portion of the image data in one or more image processing applications comprises:
using all of the image data in one or more image processing applications.
